(19) United States
(12) Patent Application Publication
(10) Pub. No.: US 2025/0264498 A1
(43) Pub. Date: Aug. 21, 2025

(54) KITS, SYSTEMS, AND METHODS FOR TRANSFERRING SAMPLES BETWEEN VACUUM INSTRUMENTS

(71) Applicant: Yale University, New Haven, CT (US)

(72) Inventors: Rongting Wu, Guilford, CT (US); Yu He, New Haven, CT (US); Eduardo Higino da Silva Neto, New Haven, CT (US); Aaron G. Greenberg, Mars, PA (US); Wenxin Li, New Haven, CT (US)

(73) Assignee: Yale University, New Haven, CT (US)

(21) Appl. No.: 19/058,662

(22) Filed: Feb. 20, 2025

Related U.S. Application Data
(60) Provisional application No. 63/555,577, filed on Feb. 20, 2024.

(51) Int. Cl. G01Q 30/20; G01Q 30/16; G01Q 60/10

(52) U.S. Cl. CPC G01Q 30/20; G01Q 30/16; G01Q 60/10

(57) ABSTRACT

An adapter kit for transferring a sample between a first vacuum instrument and a second vacuum instrument. The kit includes a substantially planar sample holder comprising at least one holder tab, a transfer plate comprising a sample region, at least one plate tab, and at least one connection site, all disposed outside of the sample region, and a transfer adaptor comprising at least one protrusion adapted to be connected to the transfer plate via the at least one connection site to enable rotation and translation of the transfer plate. The plate tab is insertable behind a backside of the holder tab by a rotational movement of the transfer plate.

### CROSS-REFERENCE TO RELATED APPLICATIONS

This application claims the benefit of U.S. Provisional Application No. 63/555,577, filed Feb. 20, 2024, the contents of which is hereby incorporated by reference as if disclosed herein in its entirety.

### BACKGROUND

The present technology relates to quantum materials engineering, and particularly to sample synthesis and material characterization environments that involve vacuum conditions, such as high vacuum, ultrahigh vacuum, or extreme high vacuum. The flag-type sample holder is a side-loaded holder that traditionally takes the form of a simple bare plate. FIG. 12 shows an exemplary flag-type sample holder. The flag-type holder is the standard and most commonly used sample holder in various vacuum applications, ranging from different materials synthesis techniques, such as molecular beam epitaxy (MBE), physical vapor deposition (PVD), and chemical vapor deposition (CVD), to different material characterization techniques, such as scanning tunneling microscopy (STM), angle-resolved photoemission spectroscopy (ARPES), X-ray photoelectron spectroscopy (XPS), low energy electron diffraction (LEED), and others. Many scientific instrument vendors offer different scientific instruments based on this standard flag-type sample holder, including ScientaOmicron, Specs, Prevac, Ferrovac, and others. Overall, the flag-type sample holder is widely adopted in the vacuum-related materials science community, with many of such scientific instruments using the flag-type sample holders every day in different laboratories around the world.

Unisoku is a leading scientific instrument vendor focusing on STM and its applications under ultralow temperatures (<1 K) and high magnetic field conditions. Many of such systems are operating worldwide, providing the opportunity to study the atomic-level electronic properties of the surface of materials under sub-Kelvin temperatures and high magnetic fields. Therefore, there is a rapidly growing number of premium research institutes and labs trying to integrate Unisoku instruments with the rest of the ultrahigh vacuum materials research ecosystem.

However, the difference in sample holders between the flag-type systems and Unisoku systems present difficulties. Unisoku STMs use their own specially designed sample holders, which employ a cylinder-type top-loading design and are not compatible with the standard flag-type holder. FIG. 13 shows an exemplary Unisoku sample holder. The engagement mechanism in a Unisoku sample holder is by rotation-lock, in contrast to the Omicron flag-type design which is by translation-lock. Therefore, it is difficult, or impossible in many cases, to transfer a sample grown or studied on a commonly accepted flag-type sample holder to a Unisoku sample holder to carry out comprehensive investigations on the same sample, and vice versa.

Thus, what is needed is an improved device to transfer samples between these machines while maintaining the sample under the desired vacuum conditions and without exposure to air.

### SUMMARY

According to a first aspect of the present technology, a kit for transferring a sample between a first vacuum instrument and a second vacuum instrument is provided. The kit includes a substantially planar sample holder comprising a holder tab, a transfer plate comprising a sample region, at least one plate tab, and at least one connection site, all disposed outside of the sample region, and a transfer adaptor comprising at least one protrusion adapted to connect to the transfer plate at the at least one connection site to enable rotation and translation of the transfer plate. In some embodiments, the sample holder includes an opening adjacent the holder tab and the transfer plate is sized to fit within the opening such that the at least one plate tab is insertable behind the backside of the at least one holder tab when the transfer plate is rotated after being placed in the opening.

According to another aspect of the present technology, a vacuum instrument is provided. The instrument comprises a vacuum chamber, a sample storage stage, a sample manipulator, and a kit for transferring the sample between the instrument and a second vacuum instrument. The kit comprises a sample holder, a transfer plate, and a transfer adapter.

According to another aspect of the present technology, methods for transferring samples between vacuum instruments are provided. The methods include aligning protrusions on a transfer plate with gaps in a sample holder; inserting the transfer plate into position adjacent holder tabs of the sample holder; and rotating the transfer plate until the protrusions are behind the holder tabs of the sample holder. Another method includes the protrusions of a transfer adaptor with connection sites on the transfer plate; inserting the protrusions of the transfer adaptor into the connection sites; rotating the transfer plate to align its protrusions with the gaps on the sample holder; and translating the transfer plate away from the sample holder.

Further aspects, features, and embodiments of the present technology will be apparent from the Figures and below description.

### BRIEF DESCRIPTION OF THE DRAWINGS

FIG. 1 shows an exploded view of a kit for transferring a sample between a first vacuum instrument and a second vacuum instrument according to a first embodiment of the present technology.

FIG. 2 shows a perspective view of a substantially planar sample holder according to the embodiment of FIG. 1.

FIG. 3 shows a top view of a transfer plate according to the embodiment of FIG. 1.

FIG. 4A shows a perspective view of a transfer adaptor according to the embodiment of FIG. 1.

FIG. 4B shows a side view of the transfer adaptor according to the embodiment of FIG. 1.

FIGS. 5A and 5B show front and back perspective views of components of the embodiment of FIG. 1.

FIG. 6 shows a perspective view of a Unisoku sample holder with the transfer adaptor of FIG. 4 mounted thereon and the transfer plate component of the adaptor kit according to the embodiment of FIG. 1.

FIG. 7A shows a perspective view of a transfer adaptor according to a second embodiment.

FIG. 7B shows a side view of the transfer adaptor according to the embodiment of FIG. 7A.

FIG. 8 shows a top view of a transfer plate according to an alternative embodiment of the present technology.

FIG. 9 shows a schematic view of a vacuum instrument according to an embodiment of the present technology.

FIG. 10 shows a flowchart of a method according to another embodiment of the present technology.

FIG. 11 shows a flowchart of a method according to yet another embodiment of the present technology.

FIG. 12 shows a flag-type sample plate according to the prior art.

FIG. 13 shows a Unisoku-type sample holder according to the prior art.

### DESCRIPTION

Embodiments of the current technology include systems, devices, adaptor kits, and methods for transferring samples in situ under vacuum conditions from a flag-type sample holder to a Unisoku sample holder and vice versa. Some embodiments of this technology enable a single sample to take advantage of all the advanced technologies that are compatible with these two sample holder systems. Some embodiments of the present technology include a bi-directional in situ transferrable transfer plate, which can be integrated into both the flag-type sample holder and the Unisoku sample holder. By mounting samples on this transfer plate, one can achieve uninterrupted sample transfer under vacuum from the flag-type sample holder to the Unisoku sample holder and vice versa in some embodiments.

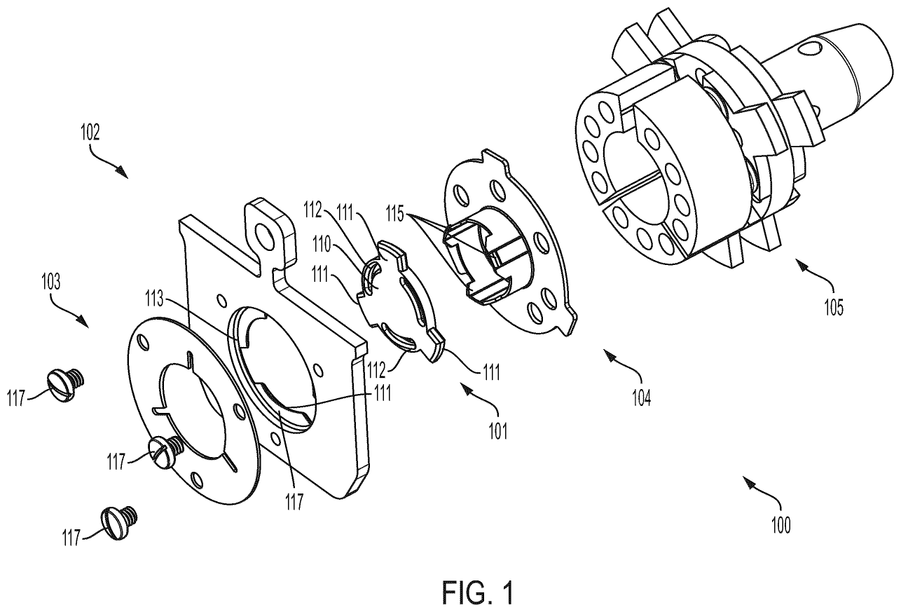

According to a first embodiment, an adaptor kit 100 for transferring a sample between a first instrument and a second instrument is shown in FIG. 1. In some embodiments, the instruments are vacuum instruments, which includes high vacuum (HV), ultrahigh vacuum (UHV), extreme high vacuum (XHV), and any other similar instruments. In some embodiments, the first instrument utilizes a flag-type sample holder, and the second instrument uses a Unisoku sample holder. In this embodiment, the kit 100 comprises an N-tabbed (where N≥1) transfer plate 101 which can be transferred between a substantially planar sample holder and a Unisoku sample holder. In some embodiments, the substantially planar sample holder is a flag-type sample holder. In some embodiments, the transfer plate 101 comprises a sample region 110, at least one plate tab 111, and at least one connection site 112. In some embodiments, the at least one plate tab 111 and the at least one connection site 112 are disposed outside of the sample region 110. An alternative view of the transfer plate 101 is provided in FIG. 3. In this embodiment, the transfer plate comprises three plate tabs 111. In other embodiments, the transfer plate has one, two, or more than three plate tabs.

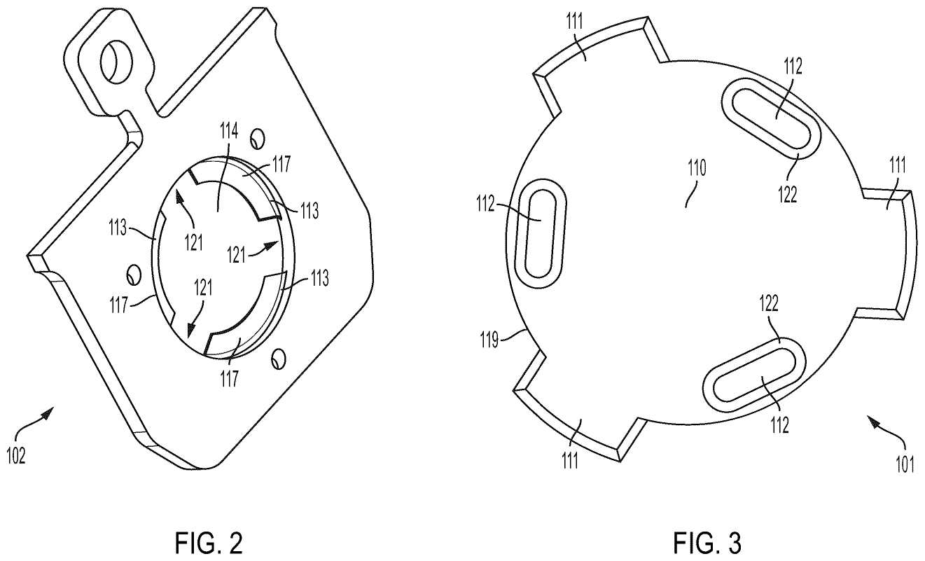

In some embodiments, the kit 100 further comprises a substantially planar, flag-type sample holder 102 comprising at least one holder tab 113. In this embodiment, the at least one plate tab 111 is insertable behind a backside 117 of the at least one holder tab 113 by a rotational movement of the transfer plate 101. An alternative view of the sample holder 102 is provided in FIG. 2, which shows the backside of the sample holder 102 of this embodiment, including the backsides 117 of the holder tabs 113 and the gaps 121 between them through which the plate tabs 111 on the transfer plate 101 pass when being translated into the opening 114 so they can be rotated behind the holder tabs 113.

In some embodiments, the kit further comprises a transfer adaptor 104 comprising at least one protrusion 115 adapted to be connected to the transfer plate 101 via the at least one connection site 112 to enable rotation and translation of the transfer plate 101. In some embodiments, the transfer adapter 104 is mountable on a Unisoku sample holder 105. The at least one protrusion 115 connects to the transfer plate 101 such that the transfer plate can be translated and rotated as a result of movement of the Unisoku sample holder in some embodiments. As will be described in additional detail below, the transfer plate 101 can then be placed into the sample holder 102, which may be secured to another instrument so that the transfer plate 101 can then be moved into the other instrument.

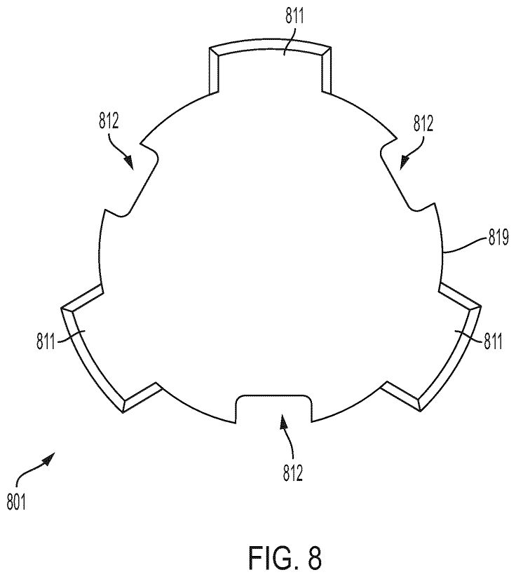

In some embodiments, the at least one connection site 112 comprises at least one slot opening, as shown in FIGS. 1, 3, 5A, 5B, and 6. In other embodiments, the connection site 112 comprises at least one notch formed on an edge of the transfer plate, as shown in FIG. 8, or a combination of a slot opening and notch.

In this embodiment, the sample holder 102 includes an opening 114 adjacent the holder tab 113, which is adapted to dock the transfer plate. In this embodiment, the opening 114 is substantially in the center of the holder 102. In this embodiment, the transfer plate 101 is sized to fit within the opening, such that the plate tab 111 is insertable behind the backside 117 of the holder tab 113 when the transfer plate is rotated after being placed in the opening 114. In this embodiment, the kit further comprises a spring plate 103 configured to be mounted on the backside of the sample holder 102 and adapted to exert a spring force against the at least one plate tab 111 of the transfer plate 101 when the plate tab is behind the backside 117 of the holder tab 113. In some embodiments, the spring plate 103 is formed of beryllium copper, molybdenum, or other suitable materials. The spring plate 103 helps to secure the transfer plate in place. In some embodiments, the three screws 120 shown in FIG. 1 also serve to adjust the spring tension.

In other embodiments, the holder tabs comprise raised planar features on the frontside surface of the sample holder. In such embodiments, the transfer plate is placed against the frontside surface and rotate so that the plate tabs 111 are moved behind the holder tabs. In some such embodiments, the holder tabs are welded or integrally formed with the sample holder.

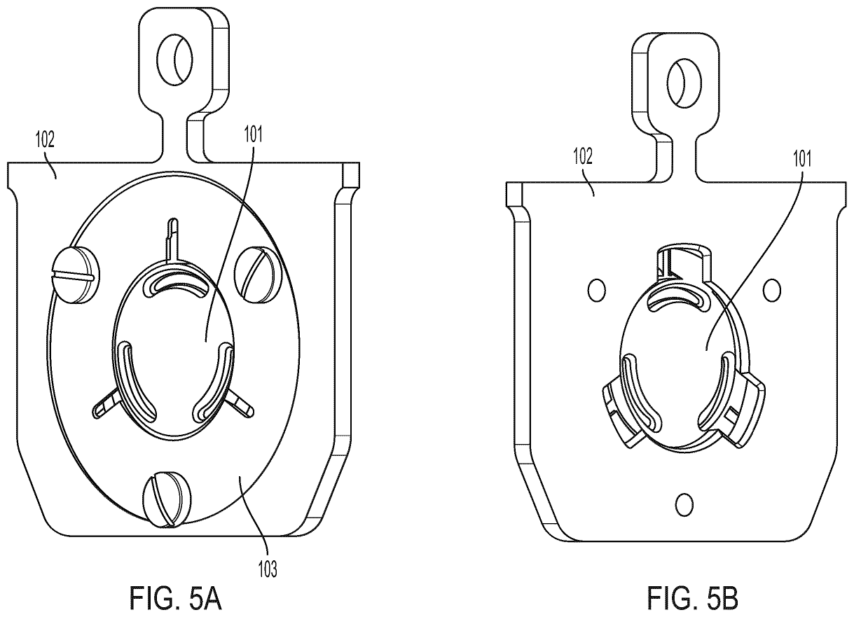

In some embodiments, the transfer plate 101 further comprises three plate tabs 111 spaced around the sample region 110 at substantially equal angles. In some embodiments, the sample holder 102 comprises three holder tabs 113 spaced at angles substantially corresponding to the spacing of the plate tabs 111 such that each plate tab 111 is insertable behind a backside 117 of one of the holder tabs 113. In such embodiments, the opening 114 comprises three gaps 121 through which the transfer plate tabs pass to engage the holder tabs. In other embodiments, where different numbers of gaps are used, the number of gaps corresponds to the number of plate tabs on the transfer plate. FIGS. 5A and 5B show alternative views of the sample holder 102 with the transfer plate 101 secured in the opening 114 of the holder 102. FIG. 5A also shows the spring plate 103 mounted on a backside of the sample holder 102, and FIG. 5B shows the frontside of the holder and the holder tabs 113.

In some embodiments, the at least one connection site 112 comprises three slot openings each positioned radially inward of the plate tabs 111 and spaced around the sample region at substantially equal angles. Radially inward means closer to a center of the transfer plate. In other embodiments, different numbers of plate tabs and slot openings are used. In some embodiments, the transfer plate has a thickness thinner than the sample holder 102. In some embodiments, the slot openings include angled periphery surfaces 122, to help guide the protrusions 115 into the slot openings. In the embodiment shown in FIG. 8, the transfer plate 801 comprises at least one connection site 812 and plate tabs 811. In this embodiment, the connection sites 812 are notches formed on the edge 819 of the plate 801. In the embodiment shown, there are three each of connection sites 812 and plate tabs 811. In other embodiments, the transfer plate comprises one notch, two notches, or more than three notches. In some embodiments, the transfer plate comprises combinations of at least one notch and at least one slot opening.

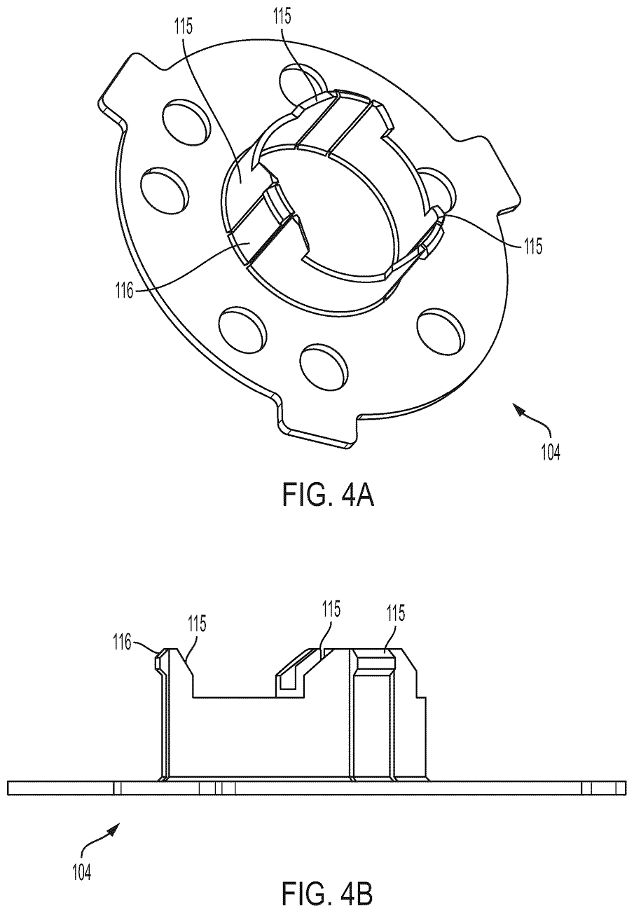

In some embodiments, the transfer adaptor 104 further comprises three protrusions 115 positioned to correspond to the spacing of the connection sites/slot openings 112 on the transfer plate 101. In this embodiment, the at least one protrusion 115 on the transfer adaptor 104 further comprises at least one leaf spring 116 adapted to exert a spring force on the transfer plate 101 via the connection site, in this embodiment, the slot opening. FIGS. 4A and 4B show alternative views of the transfer adaptor 104 according to FIG. 1. In some embodiments, such as the embodiment shown in FIGS. 1-6, each of the three protrusions include a leaf spring 116. In this embodiment, the transfer adaptor is configured to be mounted on a standard Unisoku sample holder to dock and lock the transfer plate.

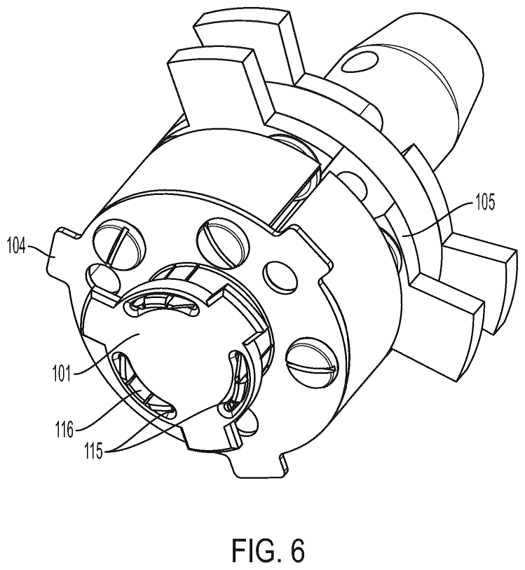

FIG. 6 shows the transfer adaptor 104 mounted via screws 123 to a Unisoku sample holder 105. The transfer plate 101 is connected to the transfer adaptor 104 by the protrusions 115 comprising leaf springs 116 that are engaged in the slot openings 112.

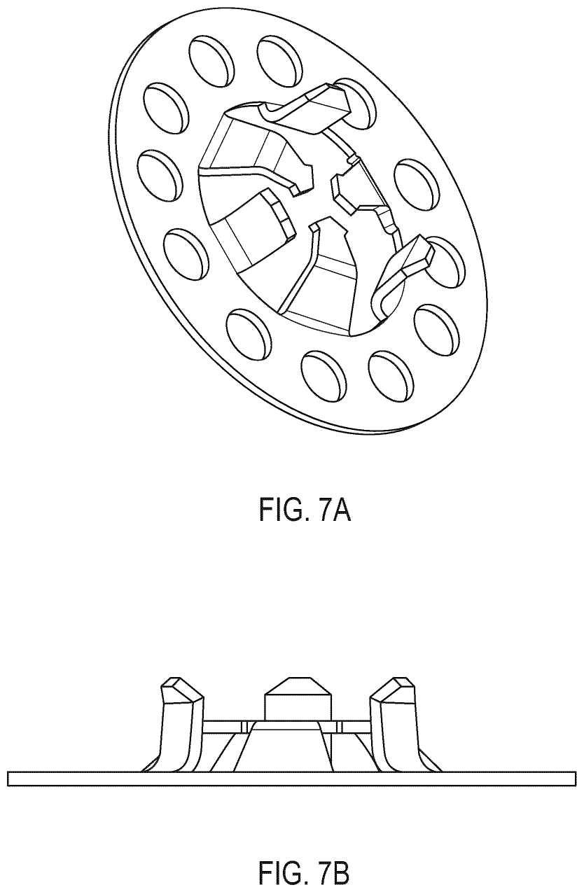

FIGS. 7A and 7B show views of a second embodiment of a transfer adaptor 704. In this embodiment, the protrusions 715 consist of leaf springs, which engage the connection site(s) on the transfer plate.

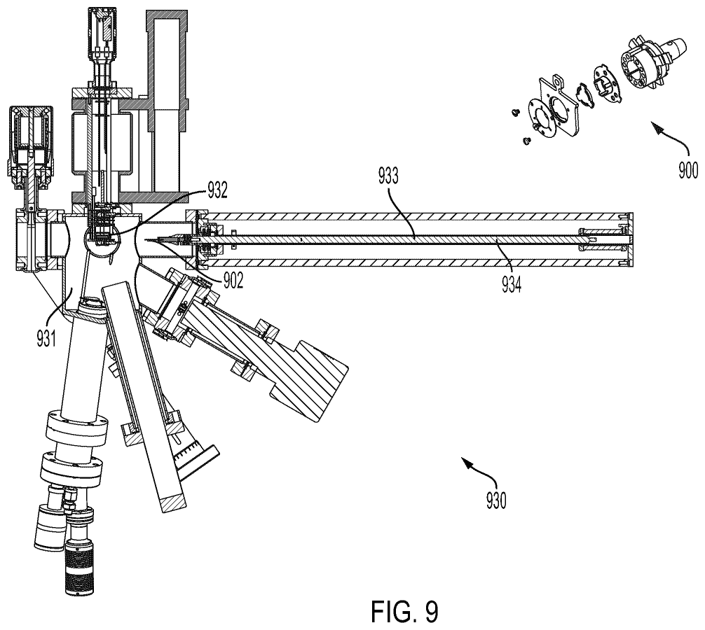

In another embodiment shown in FIG. 9, a vacuum instrument 930 is provided, which comprises a vacuum chamber 931, a sample storage stage 932, and a sample manipulator 933. As described above, in some embodiments the vacuum instrument is a high vacuum instrument. In some embodiments, the vacuum instrument is an ultrahigh vacuum instrument. In some embodiments, the vacuum instrument is an extreme high vacuum instrument. The sample manipulator 933 is adapted to translate and rotate a sample holder 902 relative to the vacuum chamber. In some embodiments, the sample manipulator comprises a rod 934 that can be twisted relative to the instrument 930 and also moved along its axis in translation.

The instrument 930 further comprises an adaptor kit 900 for transferring a sample between the instrument and a second vacuum instrument, comprising: a substantially planar sample holder comprising at least one holder tab; a transfer plate comprising a sample region, at least one plate tab, and at least one connection site, wherein the at least one plate tab and the at least one connection site are disposed outside of the sample region; and a transfer adaptor comprising at least one protrusion adapted to connect to the transfer plate at the at least one connection site to enable rotation and translation of the transfer plate. The at least one plate tab is insertable behind a backside of the at least one holder tab by a rotational movement of the transfer plate, as described above in some embodiments. In some embodiments, the substantially planar sample holder is mountable on the sample manipulator of the instrument 930. In some embodiments, the transfer adaptor is mountable on the sample manipulator of the instrument 930. Thus, in some embodiments, the sample manipulator comprises a clamp for grabbing a flag-type sample holder and in some embodiments the sample manipulator comprises a Unisoku sample holder. In some embodiments, the adaptor kit 900 has the features described above in reference to adaptor kit 100. In some embodiments, a system is provided, comprising a vacuum instrument and a kit for transferring a sample between the instrument and a second instrument is provided, where the instrument and kit comprise features as described herein.

Thus, in some embodiments of the technology, a sample is mounted (or grown, etc.) on the transfer plate 101, which has the shape of a flat plate with a thickness thinner than the standard flag-type sample holder. This transfer plate 101 has a shape with at least one protrusion 111 on its perimeter 119, which is used to integrate and lock with a sample holder 102 (e.g., one with an opening 114). In some embodiments, the transfer plate 101 has at least one connection site (such as a slot opening), which is used to integrate and lock with a Unisoku sample holder 1055 via a transfer adaptor 104. Thus, in some embodiments, the sample itself can be directly manufactured into such a shape to be transferred between a flag-type sample holder 102 and a Unisoku sample holder 105. In some embodiments, a spring plate 103 is mounted on one side of the flag-type sample holder 102 to press and lock the transfer plate 101 into the flag-type sample holder 102 while keeping the center space open to expose the sample for treatments on the flag-type sample holder.

In some embodiments, mounting the transfer plate 101 on the sample holder 102 is achieved by the following procedure:
Align the protrusion(s) 111 of the transfer plate 101 with the opening 114 and the gaps 121 of the sample holder 102.
Insert the transfer plate 101 into the opening 114. In some embodiments, the transfer plate 101 is to rest against the spring plate 103 mounted to a backside of the opening 114.
Lock the transfer plate 101 by rotating it in one direction to make the protrusion(s) 111 misalign with the gaps 121 between the holder tabs 113 of the sample holder.

In some embodiments, the combination of the transfer plate 101 with the Unisoku sample holder 105 is accomplished by following procedure:
Align the protrusion(s) 115 of the transfer adaptor 104 with the connection site(s) 112 on the transfer plate 101.
Insert the protrusion(s) 115 into the connection sites(s) 112.
Rotate the transfer plate 101 to align its protrusion(s) 111 with the gaps 121 on the sample holder 104.
Retract to pick up the transfer plate.

In such embodiments, the above-mentioned sample transfer mechanism only needs two degrees of freedom: axial motion (i.e. translation), and rotation, which can be easily achieved by commercially available transfer arms already widely equipped in the UHV systems.

According to another embodiment, an adaptor kit according to the above description is provided with a high vacuum instrument that comprises a vacuum chamber, a sample storage stage, and a sample manipulator. The sample manipulator is adapted to translate and rotate a sample holder relative to the vacuum chamber.

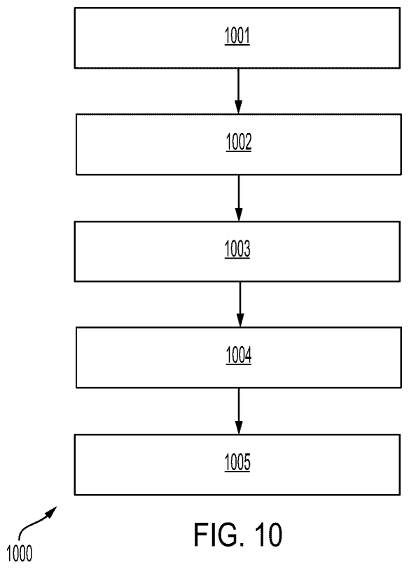

According to another embodiment of the present technology, a method 1000 of transferring a sample between a first vacuum instrument and a second vacuum instrument is provided, as shown in FIG. 10. In some embodiments, the method comprises: at 1001, mounting a substantially planar sample holder 102 comprising at least one holder tab 113 to a first sample storage stage of the first vacuum instrument; at 1002, mounting a transfer plate 101 comprising a sample region 110, at least one plate tab 111, and at least one connection site 112, wherein the at least one plate tab and the at least one connection site are disposed outside of the sample region, to the planar sample holder 102 by rotating the transfer plate 101 so that the at least one plate tab 111 is disposed behind a backside of the holder tab 113; at 1003, engaging the at least one connection site 112 on the transfer plate 101 with at least one protrusion 115 of a transfer adaptor 104 mounted on a second sample stage 105 of the second vacuum instrument; at 1004, rotating the transfer plate 101 via rotation of the second sample stage until the at least one plate tab 111 is aligned with at least one gap 121 in the planar sample holder 102; and, at 1005, translating the transfer plate 101 away from the planar sample holder 2 via translation of the second sample stage.

In some embodiments, the step of engaging 1003 the at least one connection site 112 with at least one protrusion 115 further comprises applying a spring force to the transfer plate 101 via at least one leaf spring 116 associated with the at least one protrusion 115. In some embodiments, the step of mounting 1002 a transfer plate 101 to the planar sample holder 102 further comprises applying a spring force against a backside of the at least one plate tab 111 via a spring plate 103 mounted on the backside of the planar sample holder 102.

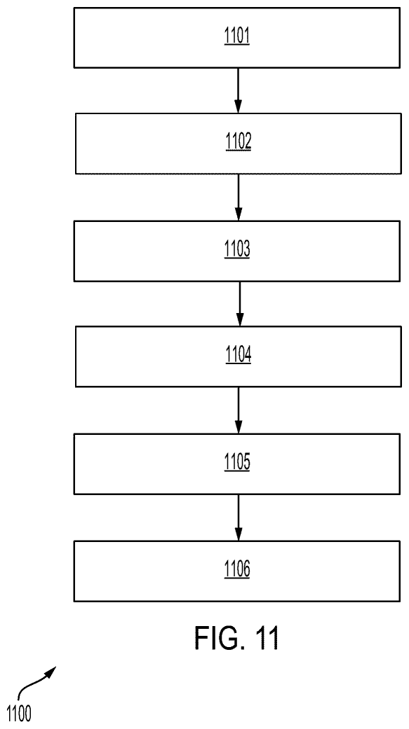

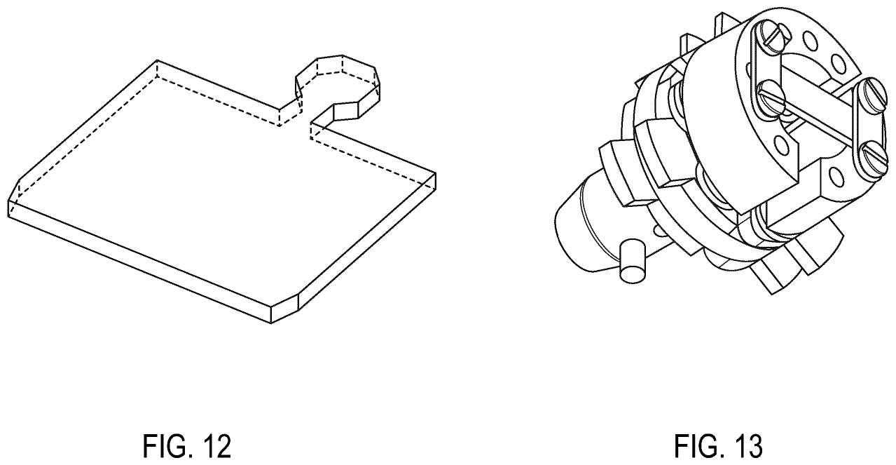

According to another embodiment of the present technology, a method 1100 of transferring a sample between a first vacuum instrument and a second vacuum instrument is provided as shown in FIG. 11, which comprises: at 1101, mounting a transfer adaptor 104 comprising at least one protrusion 115 to a first sample storage stage 105 of the first vacuum instrument; at 1102, mounting a transfer plate 101 comprising a sample region 110, at least one plate tab 111, and at least one connection site 112, wherein the at least one plate tab and the at least one connection site are disposed outside of the sample region, to the transfer adaptor; at 1103, engaging the at least one connection site 112 on the transfer plate 101 with the at least one protrusion 115 of the transfer adaptor 104; at 1104, rotating the transfer plate 101 via rotation of the first sample stage until the at least one plate tab 111 is aligned with at least one gap 121 in the planar sample holder 102 mounted to a second sample storage stage of the second vacuum instrument; at 1105, translating the transfer plate 101 toward the substantially planar sample holder 102 wherein the substantially planar sample holder 102 comprises an opening 114 adapted to receive the transfer plate 101 and at least one holder tab 113; and, at 1106, rotating the transfer plate 101 via rotation of the first sample stage until the at least one plate tab 111 is disposed behind a backside of the holder tab 113.

In some embodiments, the step of engaging 1103 the at least one connection site 112 with at least one protrusion 115 further comprises applying a spring force to the transfer plate 101 via at least one leaf spring 116 associated with the at least one protrusion 115. In some embodiments, the substantially planar sample holder 102 further comprises a spring plate 103 mounted on a backside of the substantially planar sample holder 102 for applying a spring force against a backside of the at least one plate tab 111.

Thus, some embodiments of the current technology provide devices, kits, systems, and methods that enable the transfer of samples under vacuum conditions between the commonly used flag-type sample holders in the materials science community and the Unisoku sample holder for efficient sub-Kelvin temperature and high magnetic field applications.

Although the technology has been described and illustrated with respect to exemplary embodiments thereof, it should be understood by those skilled in the art that the foregoing and various other changes, omissions and additions may be made therein and thereto, without parting from the spirit and scope of the present technology. It should also be understood that features described and illustrated in reference to one embodiment may be employed in other embodiments as appropriate.

1. An adaptor kit for transferring a sample between a first vacuum instrument and a second vacuum instrument, comprising:
a substantially planar sample holder comprising at least one holder tab;
a transfer plate comprising a sample region, at least one plate tab, and at least one connection site, wherein the at least one plate tab and the at least one connection site are disposed outside of the sample region; and
a transfer adaptor comprising at least one protrusion adapted to connect to the transfer plate at the at least one connection site to enable rotation and translation of the transfer plate;
wherein the at least one plate tab is insertable behind a backside of the at least one holder tab by a rotational movement of the transfer plate.

2. The kit of claim 1, wherein the at least one connection site comprises at least one slot opening, at least one notch formed on an edge of the transfer plate, or combinations thereof.

3. The kit of claim 1, wherein the sample holder further comprises an opening adjacent the holder tab and wherein the transfer plate is sized to fit within the opening such that the at least one plate tab is insertable behind the backside of the at least one holder tab when the transfer plate is rotated after being placed in the opening; and
the kit further comprising a spring plate mounted on the backside of the sample holder adapted to exert a spring force against the at least one plate tab of the transfer plate when the at least one plate tab is behind the backside of the at least one holder tab.

4. The kit of claim 3, wherein the transfer plate further comprises three plate tabs spaced around the sample region at substantially equal angles; and
wherein the sample holder comprises three holder tabs spaced at angles substantially corresponding to the spacing of the plate tabs such that each plate tab is insertable behind a backside of one of the holder tabs and the opening comprises three gaps through which the plate tabs pass to engage the holder tabs.

5. The kit of claim 4, wherein the at least one connection site comprises three slot openings each positioned radially inward of the plate tabs and spaced around the sample region at substantially equal angles; and
wherein the transfer adaptor further comprises three protrusions positioned to correspond to the spacing of the slot openings.

6. The kit of claim 5, wherein at least one of the protrusions on the transfer adaptor further comprises at least one leaf spring adapted to exert a spring force on the transfer plate via at least one of the slot openings.

7. A vacuum instrument, comprising:
a vacuum chamber;
a sample storage stage;
a sample manipulator, adapted to translate and rotate a sample holder relative to the vacuum chamber; and
an adaptor kit for transferring a sample between the instrument and a second vacuum instrument, comprising:
a substantially planar sample holder comprising at least one holder tab;
a transfer plate comprising a sample region, at least one plate tab, and at least one connection site, wherein the at least one plate tab and the at least one connection site are disposed outside of the sample region; and
a transfer adaptor comprising at least one protrusion adapted to connect to the transfer plate at the at least one connection site to enable rotation and translation of the transfer plate;
wherein the at least one plate tab is insertable behind a backside of the at least one holder tab by a rotational movement of the transfer plate.

8. The instrument of claim 7, wherein the substantially planar sample holder is mountable on the sample manipulator.

9. The instrument of claim 7, wherein the transfer adaptor is mountable on the sample manipulator.

10. The instrument of claim 7, wherein the at least one connection site comprises at least one slot opening, at least one notch formed on an edge of the transfer plate, or combinations thereof.

11. The instrument of claim 10, wherein the sample holder further comprises an opening adjacent the holder tab and wherein the transfer plate is sized to fit within the opening such that the at least one plate tab is insertable behind the backside of the at least one holder tab when the transfer plate is rotated after being placed in the opening; and
the kit further comprising a spring plate mounted on the backside of the sample holder adapted to exert a spring force against the at least one plate tab of the transfer plate when the at least one plate tab is behind the backside of the at least one holder tab.

12. The instrument of claim 11, wherein the transfer plate further comprises three plate tabs spaced around the sample region at substantially equal angles; and
wherein the sample holder comprises three holder tabs spaced at angles substantially corresponding to the spacing of the plate tabs such that each plate tab is insertable behind a backside of one of the holder tabs and the opening comprises three gaps through which the plate tabs pass to engage the holder tabs.

13. The instrument of claim 12, wherein the at least one connection site comprises three slot openings each positioned radially inward of the plate tabs and spaced around the sample region at substantially equal angles; and
wherein the transfer adaptor further comprises three protrusions positioned to correspond to the spacing of the slot openings.

14. The instrument of claim 12, wherein at least one of the protrusions on the transfer adaptor further comprises at least one leaf spring adapted to exert a spring force on the transfer plate via at least one of the slot openings.

15. A method of transferring a sample between a first vacuum instrument and a second vacuum instrument, comprising:
mounting a substantially planar sample holder comprising at least one holder tab to a first sample storage stage of the first vacuum instrument;
mounting a transfer plate comprising a sample region, at least one plate tab, and at least one connection site, wherein the at least one plate tab and the at least one connection site are disposed outside of the sample region, to the planar sample holder by rotating the transfer plate so that the at least one plate tab is disposed behind a backside of the at least one holder tab;
engaging the at least one connection site on the transfer plate with at least one protrusion of a transfer adaptor mounted on a second sample stage of the second vacuum instrument;
rotating the transfer plate via rotation of the second sample stage until the at least one plate tab is aligned with at least one gap in the planar sample holder; and
translating the transfer plate away from the planar sample holder via translation of the second sample stage.

16. The method of claim 15, wherein the step of engaging the at least one connection site with at least one protrusion further comprises applying a spring force to the transfer plate via at least one leaf spring associated with the at least one protrusion.

17. The method of claim 16, wherein the step of mounting a transfer plate to the planar sample holder further comprises applying a spring force against a backside of the at least one plate tab via a spring plate mounted on the backside of the planar sample holder.

18. A method of transferring a sample between a first vacuum instrument and a second vacuum instrument, comprising:
mounting a transfer adaptor comprising at least one protrusion to a first sample storage stage of the first vacuum instrument;
mounting a transfer plate comprising a sample region, at least one plate tab, and at least one connection site, wherein the at least one plate tab and the at least one connection site are disposed outside of the sample region, to the transfer adaptor;
engaging the at least one connection site on the transfer plate with the at least one protrusion of the transfer adaptor;
rotating the transfer plate via rotation of the first sample stage until the at least one plate tab is aligned with at least one gap in a planar sample holder mounted to a second sample storage stage of the second vacuum instrument;
translating the transfer plate toward the substantially planar sample holder via translation of the first sample stage, wherein the substantially planar sample holder comprises an opening adapted to receive the transfer plate and at least one holder tab; and
rotating the transfer plate via rotation of the first sample stage until the at least one plate tab is disposed behind a backside of the at least one holder tab.

19. The method of claim 18, wherein the step of engaging the at least connection site with at least one protrusion further comprises applying a spring force to the transfer plate via at least one leaf spring associated with the at least one protrusion.

20. The method of claim 18, wherein the substantially planar sample holder further comprises a spring plate mounted on a backside of the substantially planar sample holder for applying a spring force against the at least one plate tab when the at least one plate tab is behind the backside of the at least one holder tab.
